(19) United States
(12) Patent Application Publication
(10) Pub. No.: US 2010/0203261 A1
(43) Pub. Date: Aug. 12, 2010

(54) Localised Extraction Sytem

(75) Inventor: Douglas T.M. Kirk, Lancashire (GB)

Correspondence Address: QUARLES & BRADY LLP, ONE SOUTH CHURCH AVENUE, SUITE 1700, TUCSON, AZ, 85701-1621, US

(73) Assignee: Spray Enclosure Technologies, Inc.

(21) Appl. No.: 11/815,753

(22) PCT Filed: Feb. 8, 2006
(86) PCT No.: PCT/GB2006/000431

§ 371 Date: Mar. 2, 2009

(30) Foreign Application Priority Data
Feb. 8, 2005 (GB) 0502560.6
Nov. 3, 2005 (GB) 0522466.2

(51) Int. Cl. B05D 3/06; B05B 15/04; B05B 15/12; B05C 9/14; B05D 1/02; B05D 3/02; B05C 9/08

(52) U.S. Cl. 427/558; 118/326; 118/69; 118/642; 427/421.1; 427/372.2; 427/559; 427/314

(57) ABSTRACT

A localised extraction system (2) which allows a paint finishing process to be carried out without the need for a traditional spraybooth. The system (2) comprising a frame (36) with means to attach it about a portion of a surface which requires spraying and/or curing and/or drying, the frame (36) forming a localised containment wall thereabout, the frame (36) having an extraction means which draws air from the central aperture (38) of the frame and at the same time draws any paint overspray out of the aperture (38) for safe disposal. The frame (36) may comprise deflection means to retain overspray within the confines of the frame (36) and an optional curing unit which fits into the frames opening to cure the painted surface with the extraction operating at the same time to draw paint fumes emitted during drying. The extraction system, may additionally comprise a drying unit having means to supply a stream of forced air into the frame to facilitate drying.

The present invention relates to an extraction system for containing and removing vapours generated during application of films to a surface and, in particular, but not exclusively to the safe removal of spray mists, particulates and vapours generated during body repair and/or repainting of a vehicle.

A vehicle requiring body repair and/or repainting is subject to a number of different processes depending on the type of repair or repaint. For example the repainting process comprises a number of distinct stages including for example preparation for the paint, typically involving sanding the original surface to provide adhesion for the extra paint layers to be applied, or the removal of the paint film to provide adhesion for the layers of shaping filler that are to be applied to a dent and/or blemish in the surface. Polyester filler is normally used to reshape damaged areas to the pre-damaged state. After shaping, final surface preparation requires the application of a hi-build primer to enable final levelling and filling of very small imperfections. The hi-build primer or paint is usually applied using a spray gun or aerosol with a material transfer efficiency of between 50 to 80%. The spray gun or aerosol atomizes the paint or primer into a fine spray by using either compressed air or a propellant. The nature of this spray requires that undamaged surfaces adjacent the area to be repaired or repainted must be masked-off, that is covered, to prevent migration of the spray onto such.

The masked-off areas not only include adjacent surfaces of the vehicle, but often also adjacent vehicles and surfaces of the workshop, this is because if spray or overspray contacted clean or undamaged surfaces this would give rise to time consuming and costly removal thereof.

The paints, primers and materials used produce noxious vapours and environment and government regulations therefore require that these processes be carried out in a controlled environment such as a spray booth, preparation station or limited finish work station. Conventionally a dedicated spraybooth is provided within the workshop which provides an enclosed environment and all or part of the spraying process is carried out inside the controlled environment of the spraybooth. The spraybooth is usually equipped with an extraction system which draws the air containing the noxious vapours from the booth and then filters out hazardous chemicals therein before release of the cleaned extracted air into the atmosphere.

After the hi-build primer has been applied then it must be sanded to allow for any imperfections to be removed. Since the dedicated controlled environment is a critical resource within the workshop the vehicle or vehicle part is removed therefrom for this sanding operation. Once the sanding operations is complete the vehicle or part is re-masked and re-entered into the controlled environment for the further or final top coat of paint.

During re-assembly of painted parts of vehicles it is not uncommon to damage small areas of the newly painted surface. Typically this damaged area would have to be prepared and then repainted within the controlled environment, such as a spraybooth or limited finish workstation.

The dedicated controlled environment such as a spraybooth as mentioned above is a critical resource and the efficient and cost effective use thereof is essential to ensure profitability of the workshop. The continuous removal and re-entry of the vehicle or part thereof, whilst done to free the spraybooth for spraying and/or curing operations nevertheless leads to downtime reducing effective use of this facility. Furthermore, such a controlled environment requires a large building to house it and it is an expensive item to purchase, meaning that it is often not possible for local small workshops and garages to offer a paint and repair service. This is not only an inconvenience to the customers who must then take their vehicle to a remote dedicated bodyshop facility, but is also a loss of custom for the local workshop. Furthermore, such facilities are not mobile making it impossible to take such a repair and paint service to the customer, that is to provide a mobile repair and paint service. Without containment of paint or primer fumes, vapours or particulates produced during spraying and/or curing, such fumes vapours or particulates would enter the atmosphere leading to environmental pollution and the breathing of hazardous chemicals by the operator. Furthermore, contaminates such as dust and insects could be entrained therein, leading to a poor finish. Due to the limitations of the present systems government regulations concerning painting are often flouted with subsequent health and safety issues arising.

It is an object of the present invention to provide an extraction system which overcomes or alleviates the above described drawbacks.

In accordance with a first aspect of the present invention there is provided an extraction system comprising a containment unit with means to enclose a selected area on a surface of an object to the sprayed and/or dried, the unit having an outlet which is connectable to an extraction unit and an inlet connectable to an air source. This has the advantage that localised spraying and for drying can take place within the containment unit with any overspray and/or fumes being extracted to the extraction unit. This enables spraying and drying to take place outside the confines of a spraybooth or limited finish workstation, since only the area which is being sprayed and/or dried is confined.

The extraction system may comprise at least one flexible duct connectable between an inlet of an extraction unit and the outlet of the containment unit. This has the advantage that the duct enables movement between the extraction unit and the containment unit, enabling the containment unit to be selectively located at a position remote from the extraction unit. The extraction system may include a moveable mounting for the duct. This will enable further flexibility in the placement of the containment unit.

The extraction system may comprise an extraction unit which may comprise at least one of an inlet, an extraction pump adapted to draw fluid into the extraction unit through the inlet, a filter adapted to remove particulate and hazardous contaminates from the fluid, and an exhaust to expel cleaned fluid into the atmosphere. The extraction unit may additionally include a removable container to collect said removed contaminates and particulates.

The extraction unit may be mobile. This enables the extraction system to be used outside the confines of a workshop.

The containment unit may include at least one deflector.

The containment unit inlet may form an opening to the containment unit and may enable direction of a spray from a spray gun and/or aerosol into the containment unit. The deflector may be provided about the inlet. The deflector may include a movable shield, which may be located at least partially over the containment unit inlet any may be located adjacent said containment unit outlet.

The containment means may include a frame and the enclosing means may be a flexible media. The flexible media may comprise means to enable its attachment to at least one of the surface of the object to be sprayed and/or painted or the frame. The flexible nature of the media enables the containment means to be readily adapted to enclose a variety of different sized surface areas.

The flexible media may be replaceable and may be in the form of flexible sheeting, the attachment means may be in the form of adhesive tape.

The extraction system may comprise a curing unit.

The curing unit may comprise a light source to effect curing of a painted surface. The light source may be an ultraviolet light source and/or infrared light source. The curing unit may be adapted to fit into said containment unit inlet. The curing unit may have means to seal the inlet to contain the light from the source within the enclosure. This has the advantage that light from the light source does not leave the containment unit preventing damage by fugitive rays to operators' and bystanders' eyes. Furthermore the curing operation may give rise to hazardous gas which can be readily extracted via the extraction unit.

The curing unit may have cooling vents to enable air to enter the containment unit, this enables replacement of air extracted. The cooling vents may be shielded to prevent leakage of light from the unit.

In one embodiment the extraction system may comprise a forced air supply which may be heated. The forced air supply may be provided on an articulated arm to enable its accurate placement.

In accordance with a second aspect of the present invention there is provided a method of fluid extraction comprising the steps of enclosing a section of a surface to be sprayed and/or cured and/or dried within a containment unit and extracting fluid from the containment unit using an extraction unit.

In a preferred embodiment the method includes the step of spraying within the containment unit the said surface with a paint and/or primer whilst at the same time extracting fluid from the containment unit.

In a further preferred embodiment the method includes the step of drying or curing a painted surface within the containment unit at the same time as extracting said fluid.

The method may comprise the step of filtering said extracted fluid to remove particulate and/or contaminates.

The method may include the step of deflecting said spray within the containment unit.

By spraying within the containment unit dust and/or insects are not entrained within the spray leading to a smoother/cleaner finish. Furthermore any overspray, or fumes created are contained and safely extracted with the fluid, thereby not polluting the atmosphere or creating a breathing hazard for the operator. Also since only the area that is being painted is enclosed the unit can be small and rendered portable and usable in a confined space:

The method may include the step of heating air within the containment unit prior to spraying. This has the advantage of creating a warm air environment prior to application of paint materials. Compliant coatings, waterbourne base coat and ultra high solid top coats cannot be effectively applied if the temperature is below 15° C. This enables repairs to be carried out in unheated buildings and outdoors when the temperature is low, by creating an idea environment for the application of a particular material. Additionally by applying the heat prior to the application of a further coating, it is possible to dry or flash-off the presently painted surface.

By way of example only, specific embodiments of the invention will now be described, with reference to the accompanying drawings, in which:—

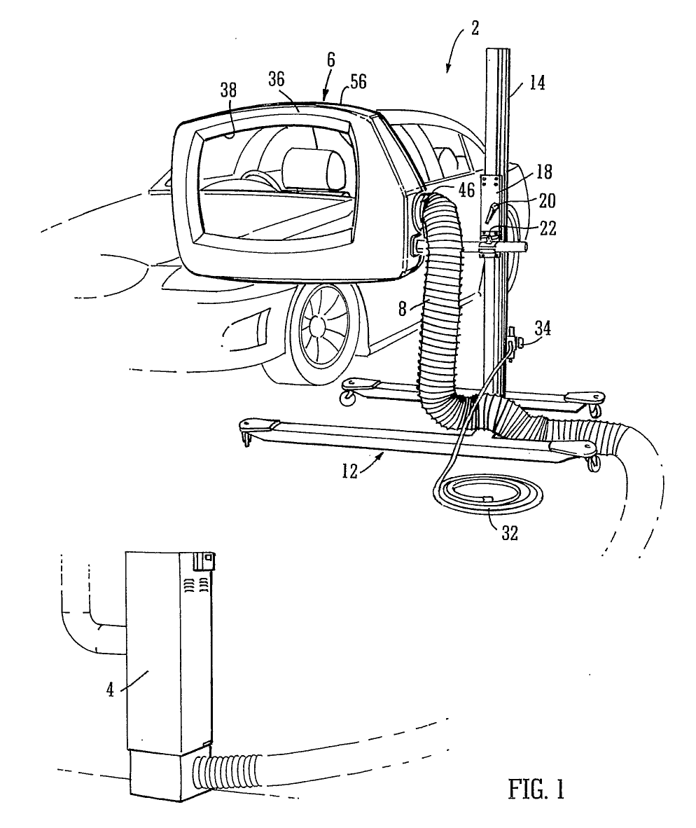

FIG. 1 is a perspective view of a first embodiment extraction system constructed in accordance with the invention;

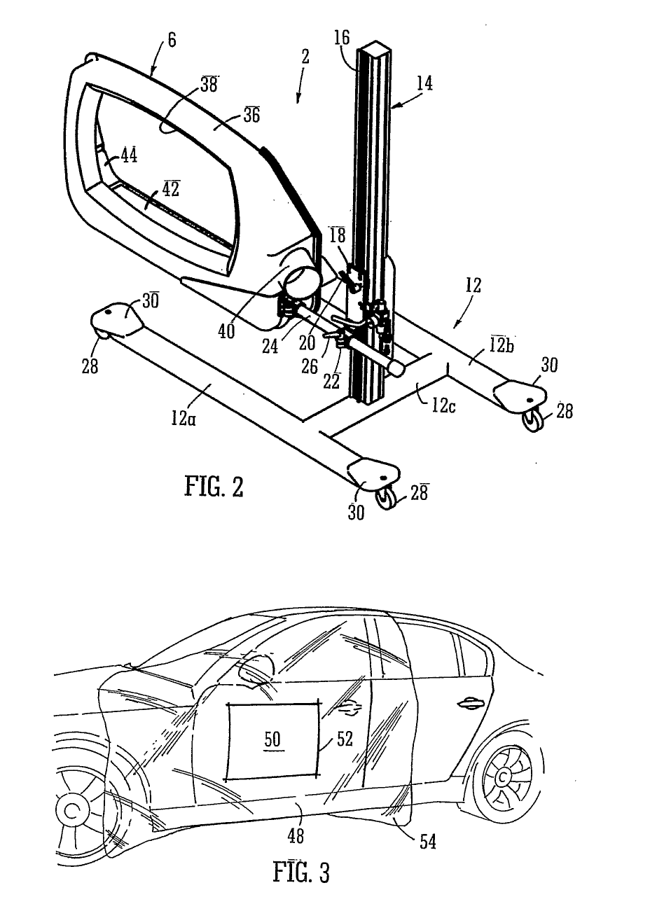

FIG. 2 is a perspective view of the hood and hood stand of the extraction system of FIG. 1;

FIG. 3 is perspective view showing the masked off area of a part to be painted to illustrate a first step in the method of using the extraction system of FIG. 1;

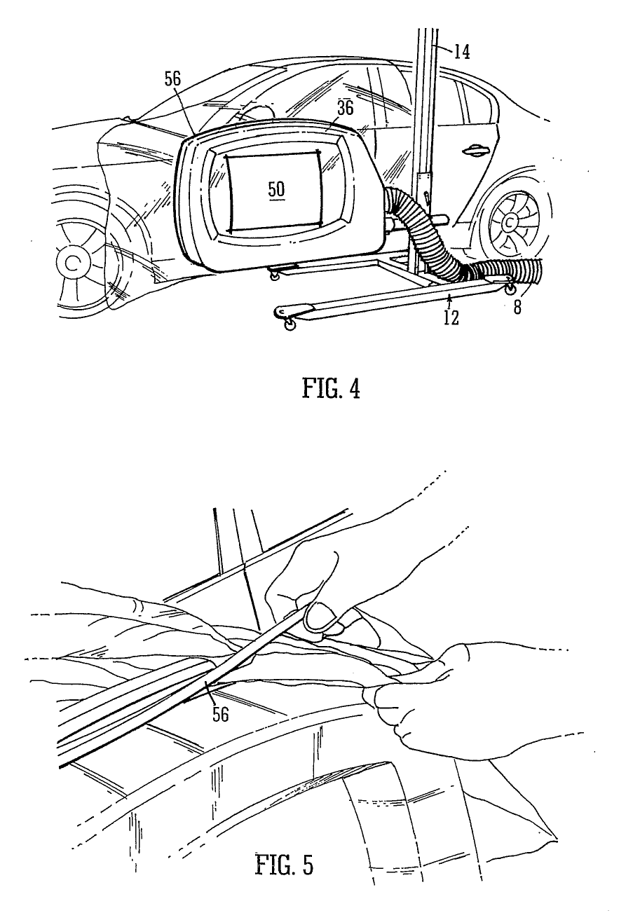

FIG. 4 is a perspective view of a second step of the method of FIG. 3 showing the hood positioned over the area to be repainted;

FIG. 5 is a perspective view showing the attachment of the masking to the hood,

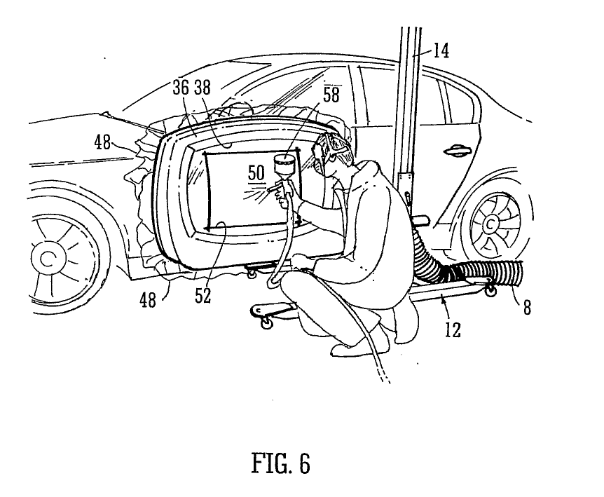

FIG. 6 is a perspective view showing the masking fully attached and paint being sprayed into the hood;

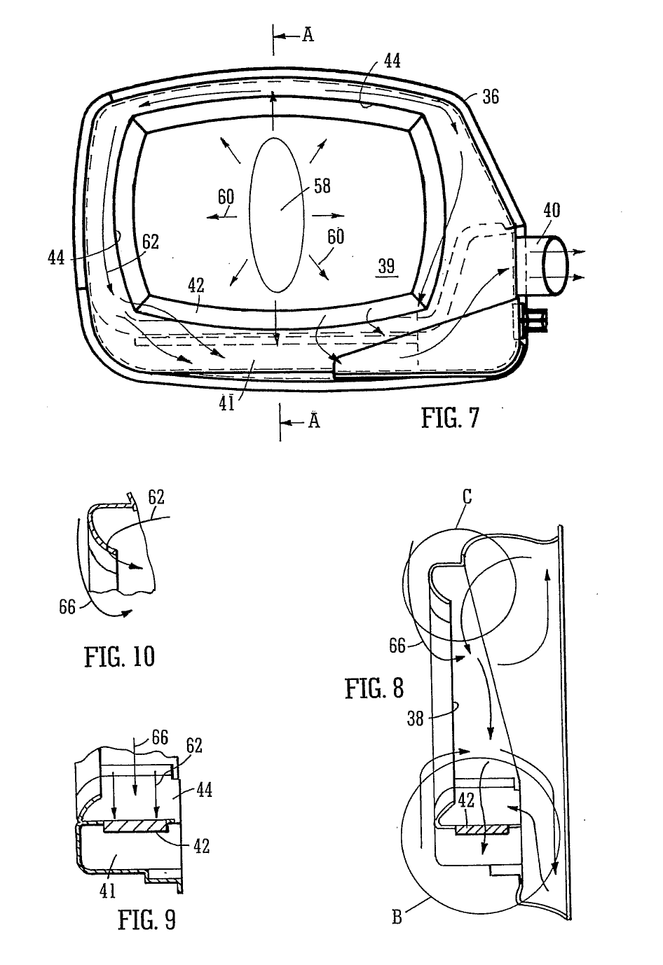

FIG. 7 is a plan view of the enclosure created by arrangement of FIG. 6 the dotted lines showing the internal cavity leading to the extraction outlet the view additionally shows spray from a spraygun and the flow path of the spray within the hood;

FIG. 8 is a sectional view through line A-A of FIG. 7;

FIGS. 9 and 10 are details of areas marked B and C respectively of FIG. 8;

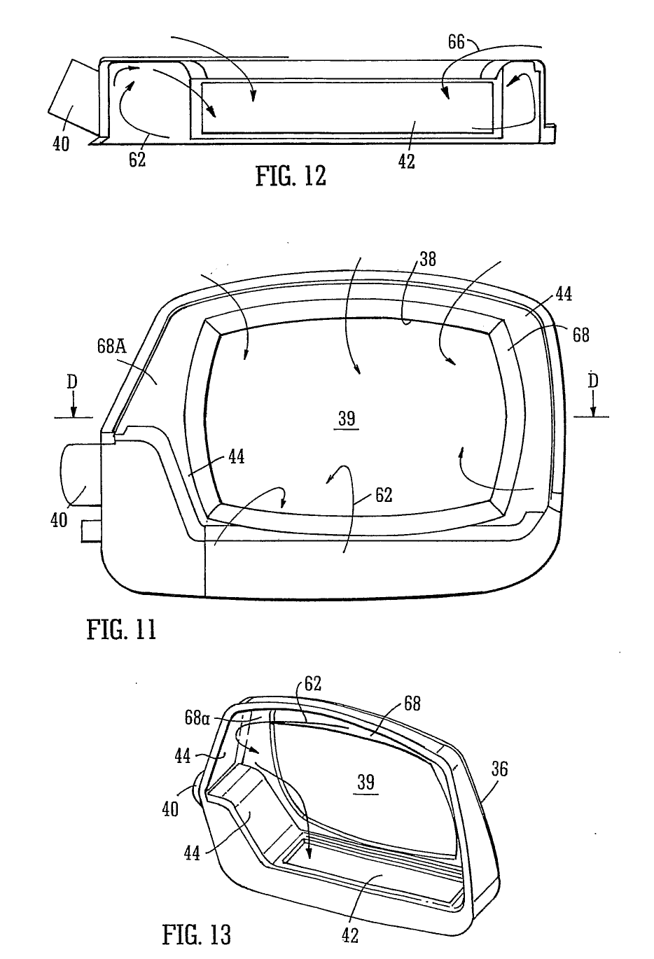

FIG. 11 is a view similar to FIG. 7 showing the reverse plan;

FIG. 12 is a sectional view along the line D-D of FIG. 11;

FIG. 13 is a perspective view of the hood showing the internal deflection surfaces and filter;

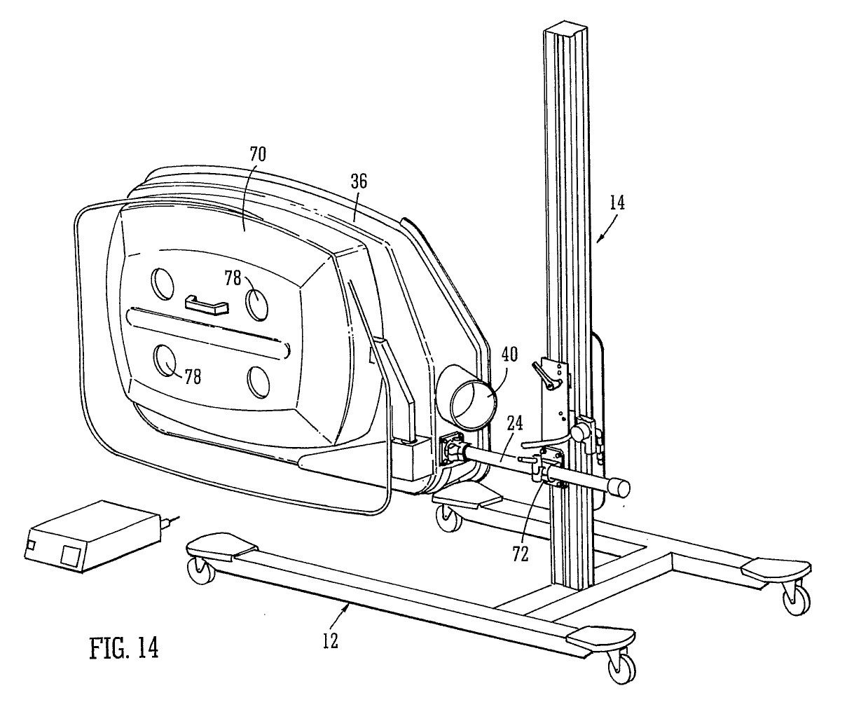

FIG. 14 is a perspective view showing use of a curing unit with the hood, the heating unit located in the opening to the hood's frame;

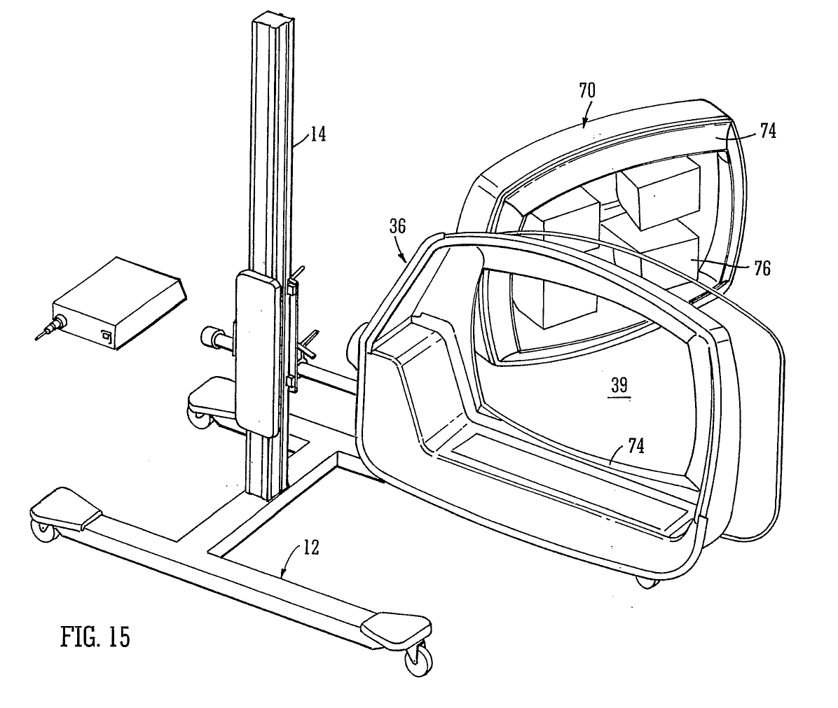

FIG. 15 is an oppositive side view similar to FIG. 14, showing the curing unit pivoted out of the opening;

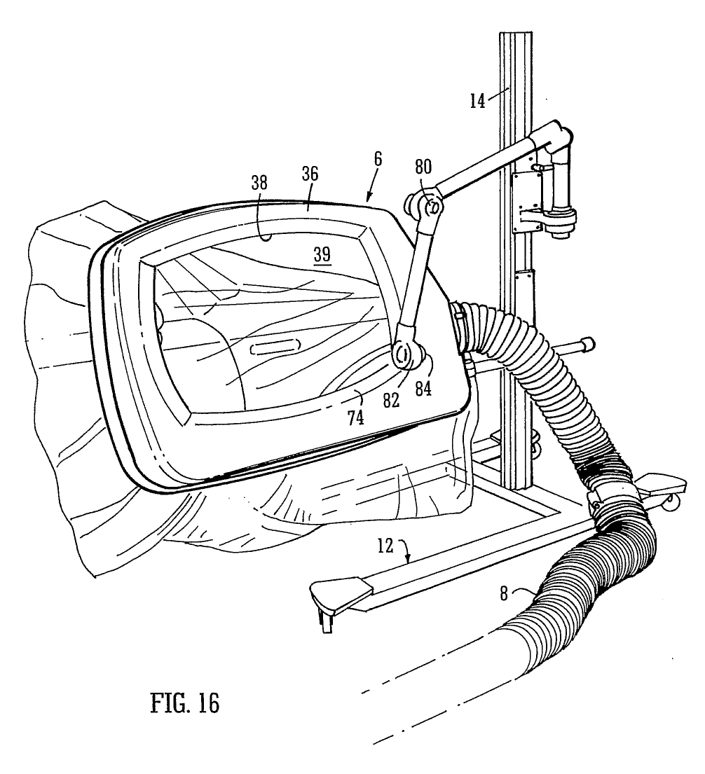

FIG. 16 is a view similar to FIG. 2 of a second embodiment of extraction unit;

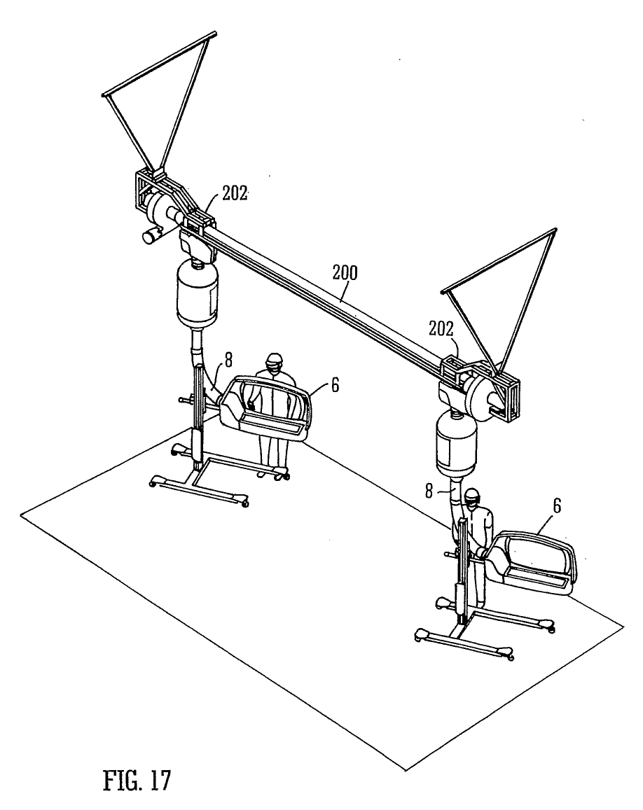

FIG. 17 is a schematic view of a third embodiment of extraction system constructed in accordance with the invention;

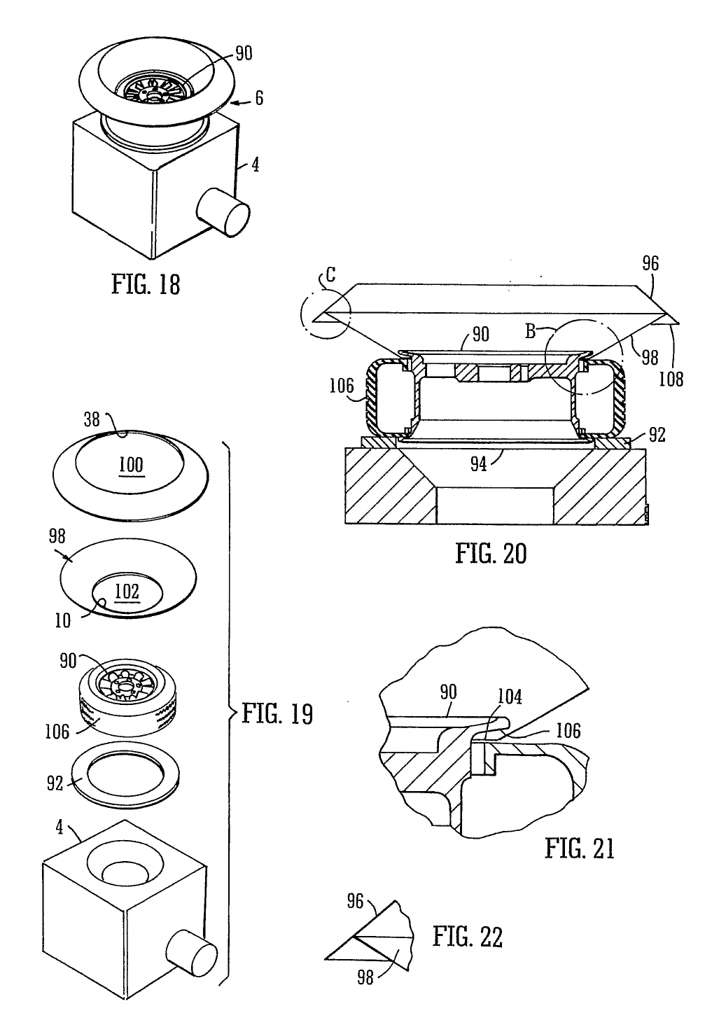

FIG. 18 is a perspective view of a fourth embodiment of extraction system constructed in accordance with the invention;

FIG. 19 is an exploded view of the extraction system of FIG. 18;

FIG. 20 is a sectional view of the extraction system of FIG. 18; and

FIGS. 21 and 22 are details of areas B and C respectively of FIG. 20.

In a first embodiment of extraction system 2, as best illustrated in FIG. 1 the system comprises an extraction unit 4, a containment unit or hood 6, and a flexible duct 8 connecting the hood 6 to the extraction unit 4.

The hood 6 is adapted to contain a selected area to be resprayed and in use paint is sprayed into the hood 6 on to the selected area, whilst the extraction unit 4 sucks air from the hood 6 via the duct 8. The interior of the hood 6 is designed to provide an aerodynamic foil which retains over-spray for extraction with the air from the hood 6. The system comprises a filter for removing hazardous gases and particulates from the extracted air, before the cleaned air is then released into the atmosphere via exhaust flue 12 of the extraction unit 4.

As best illustrated in FIGS. 1 and 2 the hood 6 is mounted on a substantially H-shaped, wheeled stand 12. The stand 12 has a mast 14 extending substantially vertically thereof which is provided with a longitudinally extending glide section 16 in which is slidably retained a hood support bracket 18. The hood support bracket 18 has a vertical adjustment handle 20 which is operable to fix the hood support bracket 18 at a desired vertical height on the mast 14, or to release the hood support bracket 18 for movement along the mast 14. The hood 6 is connected to the hood support bracket 18 for selected vertical reciprocal movement therewith by a hood guide bracket 22 which is fixed to the hood support bracket 18. A horizontally extending mounting tube 24 extends between the hood 6 and the hood guide bracket 22, with the hood 6 being fixed at one end of the mounting tube 24. The hood guide bracket 22 is in the form of a grip type retaining ring and the other end of the mounting tube 24 is slidably retained therein. The hood guide bracket 22 is provided with a swivel adjustment handle 26 which is operable to lock the position of the mounting tube 24 and thereby that of the hood 6; and a position whereby the mounting tube 24 is movable and thereby therewith the hood 6 in a transverse plane relative to the vertical plane of the mast 14, and in which the mounting tube 24 and thereby the hood 6 can also be rotated relative to its mounting in the guide bracket 22. The above described possible adjustments to the hood 6 enable a full range of movement of the hood 6 enabling its accurate positioning over a surface to be resprayed or dried.

The H-shaped stand 12 comprises two spaced apart parallel bars 12a, 12b interconnected by a cross-bar 12c. The vertically extending mast 14 is mounted to the cross bar 12c. The parallel bars 12a, 12b are provided with swizel castors 28, which enable the stand 12, 14 to be manoeuvred to a selected location such as a vehicle, a panel of which requires respray. The orientation of the hood 6 is then adjusted in order for the hood 6 to contain the panel or area requiring respray (which will be described further hereinunder). Each end of the parallel bars is provided with a moulded rubber bumper 30 which prevents damage to the wheels of the vehicle, in the instance that the stand is accidentally manoeuvred into the tyre. Furthermore the height of the stand 12 is such that the parallel bars 12a, 12b can be manoeuvred, at least partially under the chassis of the vehicle, enabling the hood 6 to be placed for example on a top surface of the vehicle, such as the hood or roof. The parallel bars 12a, 12b are spaced apart at a distance which enable them to straddle the width of the wheel.

The mast 14 additionally carries a spray gun connection pipe 32 extending from a filter regulator 34. The filter regulation 34 has for example a maximum pressure setting of 1.5 bar to ensure correct air pressure for atomisation of paint materials within the hood. In use a spray gun is attached to the free end of the spray gun connection pipe 32.

The hood 6 is a heavy duty plastics moulded design edged with a soft rubber strip to protect vehicles during use. In the illustrated example the hood 6 has a substantially rectangular outer frame 36 surrounding a through opening 38, the said hood opening 38 providing access into the containment zone created by the hood 6 for a spray gun. The hood 6 is provided with an outlet 40, which is connectable to the flexible ducting 8. The outlet 40 is connected to the hood opening 38 via an internal cavity 4 (as best illustrated in FIG. 7) provided in one of the walls of the outer frame 36. The inlet 42 the internal cavity is provided with a primary filter 42, in the form of a disposable cassette type filter. This filter removes a large proportion of the contaminants preventing such from entering the ducting 8. The interior 44 of the hood surrounding its opening 38 is shaped to provide deflection surfaces which will be described further hereinunder.

The flexible ducting 8 connecting the hood to the extraction unit 4 is provided with a quick release coupling 46 to enable its connection to the outlet 40 of the hood 6. The ducting 8 is constructed from a galvanised steel helix, which provides the ducting with strength and flexibility. The ducting 8 is coated with a PVC beading to protect vehicles from accidental damage when moving the ducting around the workshop.

The opposite end of the ducting 8 is connected to the extraction unit 4. The extraction unit 4 is provided with an extraction fan (not illustrated) in the form of a centrifugal type unit which develops high pressure to overcome system resistance, and also has a motor and a control unit. Down stream of the extraction fan the extraction unit 4 is provided with a secondary stage filter in the form of a filter bag which removes residual particles from the air stream which remain after primary filtration in the hood. This protects the components of the extraction unit from contamination, and hence prolongs the life of the extraction unit 4 and reduces maintenance costs.

The extraction unit 4 is additionally provided with a low airflow indicator and an alarm. The low airflow indicator monitors the suction of the extraction unit 4 and if it drops below a preset value, which would indicate that one or more of the filters are blinded and thereby require changing, the low airflow indicator is adapted to trigger the alarm to provide a visual and/or audible signal that the filter(s) needs changing.

The extraction system 2 is operated as follows:

As best illustrated in FIGS. 3 to 6 the areas of the item around the area to be repainted are masked using a plastics or paper media 48. The edges of the media 48 are attached around the area to be repainted 50 using masking tape 52. The hood 6 is then moved over the area 50 to be painted and the free edges 54 of the media 48 remote from the area 50 to be painted are then pulled fully round the exterior of the hood 6 and attached thereto using a resilient masking band 56 provided about the outer frame 36 of the hood 6. This opening 38 in the frame 36 thereby provides an enclosure 39 about the area to be repainted 50 which is sealed to the vehicles surface.

Access to the area to be repainted is provided through the opening 38 in the hood 6.

As best illustrated in FIGS. 7 to 13 during a spraying operation the spray nozzle 58 is placed through the opening 38 into the enclosure 39 of the frame 36 and the extraction unit 4 is switched on thereby drawing air out of the enclosure 39 via ducting 8. During spraying material 60 is applied via the spray nozzle 58 to the surface to be painted 50. Fresh air 66 is drawn in through the opening 38 from the atmosphere due to the partial vacuum created in the enclosures 39. Excess material/gases forced to the bottom edge of the enclosure 39 is extracted through the primary filter 42 into the internal cavity 41. Any excess material 62 which is deflected upwards from the corners is unable to leave the enclosure 39 via the opening 38 because the frame 36 acts as a spoiler and contact with the interior of the frame 36 causes the material 66 to lose inertia and to be deflected back down into the enclosure 39 via entrainment in the flow of incoming fresh air 66 towards the entrance 42 to the internal cavity 41.

The frame 36 is provided with overhanging shoulders 68 which extend inwardly across the hoods opening 38, these shoulders 68 provide additional deflection surfaces, to increase containment. One of the shoulders 68a located adjacent the point of extraction 42 provides a larger defection surface in this region. This is because close to the point of extraction 42 there is more disruption created and the resultant turbulence can deflect more material 62 upwards at this region. The remaining shoulders 68 of the frame 3b create a further surface area to deflect and thereby contain any excess material.

In a second embodiment of extraction unit as best illustrated in FIGS. 14 and 15. Once spraying is complete, the spraying nozzle 50 can be removed, a curing unit 70 then can be fitted to the enclosure 39. To this end a curing unit mounting bracket 72 is provided on the mounting tube 24, which bracket 72 provides a pivotal stand for the curing unit 70. The curing unit 70 is then adapted to seal the enclosure 39 by pivoting it to fit into the opening 38 of the frame 36 to provide a completely sealed unit for a curing operation. To this end the frame 36 of the hood 6 and the surface of the curing unit is provided with complementary slopping mating surfaces 74 which provide a light fast seal. The curing unit 70 can comprise a light source 76 such as an infrared or ultra violet light source to cure the paint. The curing unit 70 has a power supply and a control unit which is used to program the curing cycle. The curing unit is provided with a microswitch which only allows operation of the curing unit when it is fully within the opening so as to provide a light seal. The curing unit 70 is also provided with cooling vents 78 enabling air to be drawn in to the enclosure 39. The cooling vents 78 are provided with a light seal. During use of the curing unit 70 the extraction unit 4 is operated to draw air from the enclosure 39, thus removing and containing any gases created during curing.

In a second embodiment of extraction system as illustrated in FIG. 16 the system 2 comprises a heating unit which comprises an articulated arm 80 mounted at one end to the mast 14. The other end of the arm 80 carries an air blowing system 82 having an outlet nozzle 84, the air blowing system comprises a heater for warming the air. In use the articulated arm 80 is foldable to hold the air blowing system 82 remote from the opening 38 to the hood 6, or can be deployed to insert the outlet nozzle 84 of the air blowing system through the opening 38 at a desired location, or to direct an air stream from the blowing system into the hood 6. The air blowing system 80 is particular useful for drying water based paints in colder climates by providing additional turbulence and heat about the surface of the area to be dried and creating correct temperature for drying; water based paints generally require temperatures in the region of 15 to 40° C. to dry. The air blowing system 80 can be directed to provide an air jet obliquely towards the surface to be dried and thereby obliquely to the inflow of air through the opening into the hood created by the operation of the extraction unit 4, by this means the air from the air blowing system 80 disrupts the inflowing downdraft of air into the enclosure 39 of the hood 6 causing turbulence therein, with the formation of air vortices along the painted surfaces which accelerates drying thereof. The extraction of air during the drying process by the extraction unit 4 also extracts vapours and particulates from the drying paint for safe containment, whilst the deflection of the hoods internal surfaces 44 contain such within the hood for extraction.

It is to be understood that the hood 6 can be of any shape and/or size and that the deflection shoulders could be omitted, or the deflection surfaces could be adjustable. Also a variety of different hoods could be provided with each extraction unit 4, by this means a suitably sized and shaped hood can be selected for the area requiring repainting. Alternatively the hood can have adjustable sides. Likewise the curing unit could be adapted to provide a fit to a variety of hoods. A plurality of curing units could be provided each having a different curing system, such that a means of curing most suitable to the type of paint to be cured can be selected. Alternatively a plurality of different curing means may be provided within a single unit. Although the curing unit has been described as fitting into the opening, other arrangements could be envisaged, for example the curing unit could be fixed in the containment unit. Whilst a manual adjustment of the position of the hood as been described, the stand and mast could be provided with pneumatic means to power the adjustment of the orientation of the head.

Although a fixed extraction unit has been described, other forms of extraction unit could be used for example a mobile extraction unit on wheels. The extraction unit could be provided with a containment unit to collect the extracted contaminants for safe disposal. In a third embodiment of extraction system as best illustrated in FIG. 17 the duct is mounted on a rail 200 via a trolley moveable 202 along the rail. The rail 200 can be fitted at a low level close to the floor of a workshop, or to a ceiling of a working shop. The duct 8 and hood 6 can then be moved around the workshop to an area where it is required. The duct 8 is connected into a fixed extraction and filtration unit (not illustrated). This can be that of the fixed spraybooth in the workshop, or a separately provided system. As illustrated a plurality of different ducts can be connected into the extraction and filtration unit, enabling several repair operations to be simultaneously performed, or for different lengths of duct to be used.

It is to be understood that although the duct has been described as being moveably mounted to a rail, the duct may be fixed directly to the filtration and extraction unit.

Although the enclosure has been described as being formed by the attachment of a flexible sheeting to the hood by means such as masking band, other forms of attachment could be used such as for example masking tape or Velcro™. Also, the hood could alternatively include a flexible skirt with magnetic means to enable its attachment to metallic surface of an item to be repaired, thereby dispensing with the need for separate sheeting. Although the hood has been described as being constructed of a heavy duty plastics material, it could be constructed from other materials.

Although vehicles have been specifically described it is to be understood that other items requiring spraying and for drying are included such as garage doors, furniture including garden furniture, fencing and appliances requiring repair.

In a fourth embodiment of extraction system 2 as illustrated in FIGS. 18 to 22 the extraction system 2 is specially adapted to contain a portion of a particular item to be sprayed, in this instance the hub 90 of a wheel. In this embodiment the extraction unit 4 provides a base upon which the wheel is mounted. A seal ring 92 is provided about the inlet 94 to the extraction unit 4. The sealing ring 92 is rotatable, thereby providing a turntable. The hood 6 comprises a fume ring 96 and a masking ring 98. The fume ring 96 and masking ring 98 each have outwardly inclined surfaces 96a and 98b respectively and are fitted together to form an enclosure 39. The central aperture 100 to the fume ring 96 forms the opening 38 to the hood 6, whilst the central aperture 102 to the masking ring 98 forms the outlet 10 to the hood 6. The central aperture 102 of the masking ring 98 is provided with inwardly extending shoulders 104 inclined surfaces 96a, 98b of the rings 96, 98 form the internal deflection surfaces of the hood 6.

In use the tyre 106 of a wheel whose hub 90 requires respray is deflated and placed over the inlet 94 of the extraction unit 4 such that its sealing ring 92 contacts the tyre 106 or the wheel. The hood 6 is then placed over the wheel by initially placing the masking ring 98 about the exposed hub 90 surface by fitting its inwardly extending shoulders 104 under the rim 106 of the hub 90, as best illustrated in FIG. 21, which is accessible due to the deflation of the tyre 106. The fume ring 96 is then placed over the masking ring 98 to complete the hood 6.

The system is operated by switching on the extraction unit 4 which draws air into the hood 6 opening 38 down through the hood 6, through the aperture provided in the hub 90, into the extraction unit 4. The hub 90 is sprayed by spraying into the opening 38 of the hood 6, with the overspray being contained as in previous embodiments by deflection by the effective aerofoil created by the internal surfaces of the hood. The operation of the extraction unit 4 helps to provide an air tight enclosure about the hub 90, whilst the masking rings 96 shoulders 104 protect the tyre 106 from the paint spray.

The masking ring 98 is adjustable in that is annular shape is created by a strip which is overlapped with a sliding fit, with the degree of overlap being adjusted to alter the size of the central aperture 102 to best fit about the rim 106 of the particular hub 90. The fume ring 96 has a greater outer diameter 108 than that of that of the masking ring 98, in that it always overlaps its outer edge of the masking ring 96 regardless of the size its diameter is adjusted to.

A curing unit and/or heating unit can be inserted into or adjacent to the opening into the hood to facilitate curing and/or drying as per the previous embodiment.

Although the base has been described as the extraction unit, the base could merely provide an inlet to the extraction unit which unit may be provided remotely and connected thereto by ducting.

The invention is not restricted to the above described embodiments and many modifications and variations will readily occur to one skilled in the art.

1-44. (canceled)

45. A localised spraybooth used to contain and remove vapours generated during applications of films to a surface, the localised spraybooth comprising a containment unit with means to enclose a selected area on said surface, the containment unit having an outlet which is connectable to an extraction unit and an inlet connectable to atmospheric air, wherein the containment unit comprises a frame which provides an outer containment wall which surrounds a through opening, which through opening forms the inlet to said containment unit, and wherein enclosing the means is a flexible media the flexible media having means to enable its attachment to said surface.

46. A localised spray booth according to claim 45, comprising at least one flexible duct connectable between an inlet of an extraction unit and the outlet of the containment unit.

47. A localised spraybooth according to claim 45, comprising at least one flexible duct having a movable mounting and which duct is connectable between an inlet of an extraction unit and the outlet of the containment unit.

48. A localised spraybooth according to claim 45, comprising an extraction unit having at least one inlet, an extraction pump adapted to draw fluid into the extraction unit through the inlet from the containment unit, and an exhaust to expel cleaned fluid into the atmosphere.

49. A localised spraybooth according to claim 45, comprising an extraction unit having an extraction pump and at least one filter upstream of the extraction pump.

50. A localised spraybooth according to claim 45, comprising an extraction unit and at least one filter provided at least at one of the outlet to the containment unit and an inlet to the extraction unit.

51. A localised spraybooth according to claim 45, comprising a mobile extraction unit.

52. A localised spraybooth according to claim 45, comprising an adjustable support for the containment unit which enables the position of the containment unit to be adjusted.

53. A localised spraybooth according to claim 45, comprising at least one air deflector.

54. A localised spraybooth according to claim 45, comprising at least one adjustable air deflector.

55. A localised spraybooth according to claim 45, comprising at least one air deflector provided about at least one of the inlet to the containment unit and an interior surface of the containment unit.

56. A localised spraybooth according to claim 45, comprising at least one air deflector having an enlarged deflection surface adjacent to the outlet to the containment unit.

57. A localised spraybooth according to claim 45, wherein the flexible media is replaceable and comprises flexible sheeting and the attachment means comprise at least one of a resilient band to entrap the sheeting around the frame, and adhesive tape.

58. A localised spraybooth according to claim 45, wherein the enclosing means is a flexible skirt provided about the frame.

59. A localised spraybooth according to claim 45, comprising a curing unit.

60. A localised spraybooth according to claim 45, comprising a curing unit which is adapted to fit into the inlet to the containment unit.

61. A localised spraybooth according to claim 45, comprising a curing unit having cooling vents to enable air to enter the containment unit.

62. A localised spraybooth according to claim 45, comprising a curing unit provided on an arm which has means to move the curing unit into and out of the inlet to the containment unit.

63. A localised spraybooth according to claim 45, comprising a curing unit having a light source including at least one of ultraviolet and infrared.

64. A localised spraybooth according to claim 45, comprising a curing unit including a light source and means to seal the containment unit inlet to contain the light from the source within the containment unit.

65. A localised spraybooth according to claim 45, comprising a curing unit having a light source and cooling vents which are shielded to prevent light leakage.

66. A localised spraybooth according to claim 45, comprising a drying unit and means to supply a stream of air into the inlet of the containment unit via the drying unit.

67. A localised spraybooth according to claim 45, comprising a drying unit with means to supply a stream of air into the containment unit and a heater to heat said stream of air.

68. A localised spraybooth according to claim 45, comprising a drying unit mounted on an articulated arm.

69. A localised spraybooth according to claim 45, comprising a drying unit which has an air nozzle and a forced air supply.

70. A localised spraybooth according to claim 45, comprising an extraction unit, the extraction unit having means to mount a wheel to be at least one of sprayed and dried between the containment unit and the extraction unit, said mounting means comprising a seal.

71. A localised spraybooth according to claim 45, comprising an extraction unit with an annular turntable provided about an inlet to the extraction unit.

72. A method of fluid extraction comprising providing a localised spraybooth to contain and remove vapours generated during application of films to a surface, the spraybooth comprising a containment unit in the form of a frame which provides an outer containment wall surrounding a through opening which opening forms an inlet into the containment unit for the application of said films, the method comprising the steps of providing a flexible media about the frame and enclosing a selected area on said surface with the flexible media and extracting fluid from the containment unit using an extraction unit.

73. A method according to claim 72 including the additional step of spraying within the containment unit the said surface with paint and/or primer whilst at the same time extracting fluid from the containment unit.

74. A method according to claim 72, comprising the step of spraying within the containment unit and deflecting said spray within the containment unit to confine it within the containment unit for extraction with said fluid.

75. A method according to claim 72, wherein said fluid comprises air drawn into the containment unit by the extraction unit.

76. A method according to claim 72, comprising the additional step of at least one of curing and drying a painted surface within the containment unit at the same time as extracting said fluid.

77. A method according to claim 72, comprising the step of drying a painted surface within the containment unit at the same time as extracting said fluid and includes directing an air source into the containment unit obliquely to the painted surface.

78. A method according to claim 72, wherein said fluid comprises air drawn into the containment unit by the extraction unit, and includes the additional step of directing a further air source obliquely to the drawn air.

79. A method according to claim 72, comprising the step of curing a painted surface within the containment unit using at least one of an infrared or ultraviolet light source.

80. A method according to claim 72, comprising the step of filtering said extracted fluid to remove at least one of particulates and contaminates.

81. A method according to claim 72, comprising the step of adjusting the size of the containment unit.

82. A method according to claim 72 including the step of providing heated air into the containment unit before spraying.
